(19) United States
(12) Patent Application Publication
(10) Pub. No.: US 2010/0204407 A1
(43) Pub. Date: Aug. 12, 2010

(54) POLYMERIZATION OF VINYLIC MONOMERS CONTAINING A HETEROATOM

(76) Inventors: Gilbert C.E. Bouquet, Gent (BE); Sascha Rulhoff, Halle (DE)

Correspondence Address: The Dow Chemical Company, P.O. BOX 1967, Midland, MI, 48641, US

(21) Appl. No.: 12/677,569

(22) PCT Filed: Sep. 12, 2008
(86) PCT No.: PCT/US2008/076101

§ 371 Date: Mar. 11, 2010

Related U.S. Application Data
(60) Provisional application No. 60/993,614, filed on Sep. 13, 2007.

(51) Int. Cl. C08F 4/46; C08F 4/00; C08F 4/52; C08F 220/44; C08F 293/00

(52) U.S. Cl. 525/238; 526/89; 526/173; 526/177; 526/342

(57) ABSTRACT

A process for the anionic polymerization of monomers, by the step of polymerizing the monomers in the presence of an initiator composition comprising a metal hydride such as sodium hydride and an organyl metal compound such as triisobutylaluminum, the monomers comprising one or more vinylic monomers comprising one or more elements different from carbon and hydrogen.

### CROSS REFERENCE STATEMENT

This application claims the benefit of U.S. Provisional Application No. 60/993,614 filed Sep. 13, 2007.

### BACKGROUND

The instant invention relates to anionic polymerization of monomers and more specifically to retarded anionic polymerization of monomers comprising monomers containing a heteroatom.

As discussed by Desbois et al. in US Patent Application Publication 2006/0058177, anionic polymerization generally proceeds very rapidly with a corresponding rapid liberation of heat which makes control difficult on an industrial scale. If the polymerization temperature is lowered to reduce the reaction rate, the result can be an excessive rise in viscosity of the reaction mixture. Reducing the anionic polymerization initiator concentration increases the molecular weight of the resulting polymer. Control of the reaction rate by way of dilution of the monomers leads to a higher requirement for solvent and to reduced yields. As discussed by Bowden in Macromol. Chem. Phys. 2006, 207, 1917-1920, “retarded anionic polymerization” is a better means of controlling anionic polymerization. The initiator used in retarded anionic polymerization is usually a mixture of a metal hydride and an organyl metal compound.

Prior art retarded anionic polymerization techniques have not been used to polymerize monomers comprising monomers containing a heteroatom such as acrylonitrile monomer despite the significant commercial utility of polymers such as copolymers of styrene and acrylonitrile. It would therefore be an advance in the art of retarded anionic polymerization if a retarded anionic polymerization process were discovered for the polymerization of monomers comprising monomers containing a heteroatom.

### SUMMARY OF INVENTION

The instant invention is the discovery that the retarded anionic polymerization process can be used for the polymerization of monomers comprising monomers containing a heteroatom. More specifically, the instant invention is a process for the anionic polymerization of monomers, comprising the step of polymerizing the monomers in the presence of an initiator composition comprising a metal hydride and an organyl metal compound, characterized by the monomers comprising one or more vinylic monomers comprising one or more elements in addition to carbon and hydrogen.

### DETAILED DESCRIPTION

The instant invention is a process for the anionic polymerization of monomers, comprising the step of polymerizing the monomers in the presence of an initiator composition comprising a metal hydride and an organyl metal compound, characterized by the monomers comprising one or more vinylic monomers comprising a heteroatom. A vinylic monomer is a monomer containing a C≡C group. A heteroatom is an element different from carbon and hydrogen such as nitrogen, oxygen, silicon or a halogen.

Vinylic monomers include the monovinylidene aromatic monomers described in U.S. Pat. Nos. 4,666,987; 4,572,819 and 4,585,825, which are herein incorporated by reference. Vinylic monomers include unsaturated nitriles such as acrylonitrile, methacrylonitrile, ethacrylonitrile and fumaronitrile. Vinylic monomers include nitriles, esters, amides, imides or anhydrides of ethylenically unsaturated monocarboxylic acids (e.g., acrylic acid, methacrylic acid, etc) such as methylacrylate, ethylacrylate, butyl acrylate, methyl methacrylate, etc.); vinyl halides such as vinyl chloride, vinyl bromide, etc.; vinylidene chloride, vinylidene bromide, etc.; vinyl esters such as vinyl acetate, vinyl propionate, etc.; nitriles, esters, amides, imides or anhydrides of ethylenically unsaturated dicarboxylic acids (e.g. maleic acid, fumaric acid) such as maleic anhydride, maleates or fumarates, such as dimethyl maleate, diethyl maleate, dibutyl maleate, the corresponding fumarates, N-phenyl maleimide, etc.; and the like. Other vinylic monomers include conjugated 1,3 dienes (e.g. butadiene, isoprene, etc.). Preferably, the vinylic monomer comprising one or more elements in addition to carbon and hydrogen is selected from the group consisting of nitriles, esters, amides, imides, and anhydrides.

The metal of the metal hydride is preferably selected from the group consisting of Group I and Group II metals of the periodic table of elements. More preferably, the metal of the metal hydride is selected from the group consisting of LiH, NaH and KH. Most preferably, the metal hydride is NaH. Preferably, the organyl metal compound is an organyl aluminum compound. More preferably, the organyl aluminum compound is selected from the group of triisobutylaluminum and triethylaluminum.

The polymerization temperature of the process of the instant invention is preferably in the range of from 50 to 150° C. The mole ratio of the metal of the organyl metal compound to the metal of the metal hydride is preferably in the range of from 0.01 to 5. The concentration of the metal hydride is preferably in the range of from 0.0001 to 0.1 weight percent of the weight of the monomers. Although not required, the polymerization can be conducted in the presence of a solvent, such as ethyl benzene. The concentration of the one or more vinyl monomers comprising one or more elements in addition to carbon and hydrogen is preferably 1 or more weight percent of the weight of the monomers plus the weight of the solvent and wherein the concentration of the monomers is in the range of from 1 to 100 weight percent of the weight of the monomers plus the weight of any solvent.

The process for the anionic polymerization of monomers of the instant invention can be followed by radical polymerization of monomers by adding a material that stops the anionic polymerization and then polymerizing additional monomers by radical polymerization. The additional monomers can be monomers that remain from the retarded anionic polymerization and/or monomers added prior or during the radical polymerization step. The radical polymerization can be initiated by any convenient means such as heating or the addition of a radical initiator material such as a peroxide. A rubber can be added during the radical polymerization process to prepare a rubber modified polymer. Preferred rubbers are diene rubbers such as polybutadiene, polyisoprene, polypiperylene, polychloroprene, and the like or mixtures of diene rubbers, i.e., any rubbery polymers of one or more conjugated 1,3-dienes, with 1,3-butadiene being especially preferred. Such rubbers include homopolymers and copolymers of 1,3-butadiene with one or more copolymerizable monomers, such as monovinylidene aromatic monomers as described hereinabove, styrene being preferred. Preferred copolymers of 1,3-butadiene are block or tapered block rubbers of at least about 30 weight percent 1,3-butadiene rubber, more preferably from about 50 weight percent, even more preferably from about 70 weight percent, and most preferably from about 90 weight percent 1,3-butadiene rubber and up to about 70 weight percent monovinylidene aromatic monomer, more preferably up to about 50 weight percent, even more preferably up to about 30 weight percent, and most preferably up to about 10 weight percent monovinylidene aromatic monomer, weights based on the weight of the 1,3-butadiene copolymer.

The instant invention is also a polymer comprising a polymer obtained by the process of the instant invention. The polymer of the instant invention is preferably selected from the group consisting of a styrene-acrylonitrile polymer, a poly(butadiene-block-styrene-acrylonitrile polymer) and a branched styrene-acrylonitrile polymer. The polymer of the instant invention can be a functionalized styrene-acrylonitrile polymer. The term “functionalized” means a polymer having an extra functional group obtained by reacting the living polymer with a suitable functionalizing agent to, for example, modify the solubility parameter of the polymer or provide a site for a coupling reaction to, for example, another polymer or a substrate.

The instant invention is also the use of a polymer of the instant invention for producing a molding, a film, a sheet or panel or a fiber, a foam or an adhesive. The instant invention is also a molding, a film, a sheet or panel or a fiber, a foam or an adhesive comprising a polymer of the instant invention.

The instant invention also comprises the use of a poly(butadiene-block-styrene-acrylonitrile) polymer of the instant invention as a rubber compatibilizer during the synthesis of acrylonitrile-butadiene-styrene polymers (ABS) by a mass polymerization process or a mass/solution polymerization process. The instant invention also comprises a molding, a film, a sheet or panel or a fiber made from a polymer of the instant invention.

### EXAMPLE

A retarded anionic polymerization initiator composition is prepared in an inert dry atmosphere in a glove box. 0.0025 mol (0.1 g) of NaH in mineral oil (60 wt %, from Sigma-Aldrich, Milwaukee Wis.) is dissolved in 45 ml of ethyl benzene. 3.967 g of a 10 wt % solution of tri-isobutyl aluminum in cyclohexane is added with a syringe. The initiator composition is stirred for 1.5 hour. 39.1 g (0.38 mol) of styrene and 13.02 g (0.24 mol) of acrylonitrile are dissolved in 178.8 g of ethylbenzene and the resulting monomer mixture is transferred to a dry metal cylinder. A reactor is flushed with dry nitrogen for 30 minutes to dry the reactor. After the reactor is dried, the monomer solution from the cylinder is introduced into the reactor (at 50° C.) and heated to 125° C. Then, the initiator composition is added to the reactor. Samples from the reactor are taken after 60, 180, 240 and 300 minutes and the conversion of the monomers to polymer is calculated by determining the solids level as about 4, 10, 12.5 and 14 weight percent of the reaction mixture respectively. The polymerization reaction is stopped at 300 minutes by cooling the reactor to 60° C. followed by the addition of 2 mL methanol. The resulting product is isolated in a rotational evaporator at 60° C. and dried for 3 hours in a vacuum oven at 125° C. The orange product is dissolved in ethyl benzene and washed in water and dilute hydrochloric acid over night to remove the orange color. The orange color is believed to be an oligomer having a molecular weight of less than 1000 grams per mole. The resulting colorless polymer is washed three times with water and then isolated in a rotational evaporator at 60° C. and dried for 3 hours in a vacuum oven at 125° C. Characterization of the colorless product by ¹³C NMR indicates a random styrene acrylonitrile copolymer having an acrylonitrile content of about 30 mole % and a styrene content of about 70 mole %. The polymer has a weight average molecular weight (M_{w}) of 64,000 grams per mole and a number average molecular weight (Mₙ) of 37,000 grams per mole.

### CONCLUSION

While the instant invention has been described above according to its preferred embodiments, it can be modified within the spirit and scope of this disclosure. This application is therefore intended to cover any variations, uses, or adaptations of the instant invention using the general principles disclosed herein. Further, the instant application is intended to cover such departures from the present disclosure as come within the known or customary practice in the art to which this invention pertains and which fall within the limits of the following claims.

1. A process for the anionic polymerization of monomers, comprising the step of polymerizing the monomers in the presence of an initiator composition comprising a metal hydride and an organyl metal compound, characterized by the monomers comprising one or more vinylic monomers comprising one or more elements in addition to carbon and hydrogen.

2. The process of claim 1, wherein the metal of the metal hydride is selected from the group consisting of Group I and Group II metals of the periodic table of elements.

3. The process of claim 1, wherein the metal hydride is selected from the group consisting of LiH, NaH and KH.

4. The process of claim 3, wherein the metal hydride is NaH and the organyl metal compound is an organyl aluminum compound.

5. (canceled)

5. The process of claim 4, wherein the organyl aluminum compound is selected from the group of triisobutylaluminum and triethylaluminum.

6. The process of claim 1, wherein the one or more vinylic monomers comprising one or more elements in addition to carbon and hydrogen is selected from the group consisting of nitriles, esters, amides, imides, anhydrides, methacrylates and acrylates.

7. The process of claim 6, wherein the one or more vinyl monomers comprising one or more elements in addition to carbon and hydrogen comprises acrylonitrile.

8. The process of any of claim 1, 2, 3, 4, 5, 6, or 7, wherein the polymerization temperature is in the range of from 50 to 150° C., wherein the mole ratio of the metal of the organyl metal compound to the metal of the metal hydride is in the range of from 0.01 to 5, wherein the concentration of the metal hydride is in the range of from 0.0001 to 0.1 weight percent of the weight of the monomers, wherein the polymerization is conducted in the presence of a solvent, wherein the concentration of the one or more vinyl monomers comprising one or more elements in addition to carbon and hydrogen is 1 or more weight percent of the weight of the monomers plus the weight of the solvent and wherein the concentration of the monomers is in the range of from 1 to 100 weight percent of the weight of the monomers plus the weight of the solvent.

9. A polymer comprising a polymer obtained by the process as claimed in claim 8.

10. The polymer of claim 9, wherein the polymer is selected from the group consisting of a styrene-acrylonitrile polymer, a poly(butadiene-block-styrene-acrylonitrile polymer), and a branched styrene-acrylonitrile polymer.
